(19) United States
(12) Patent Application Publication
(10) Pub. No.: US 2013/0256317 A1
(43) Pub. Date: Oct. 3, 2013

(54) IN-SITU FOAM CORE THERMAL MANAGEMENT SYSTEM AND METHOD OF MANUFACTURE

(71) Applicant: Richard W. Roberts, Tecumseh, MI (US)

(72) Inventor: Richard W. Roberts, Tecumseh, MI (US)

(21) Appl. No.: 13/463,715

(22) Filed: May 3, 2012

Related U.S. Application Data
(60) Provisional application No. 61/617,045, filed on Mar. 29, 2012.

(51) Int. Cl. F25D 23/06; B32B 5/20

(52) U.S. Cl. CPC F25D 23/063; B32B 5/20
USPC 220/592.1; 428/304.4

(57) ABSTRACT

A thermal management system includes a panel having a periphery, and a skin having a thermal bond to an in-situ foam core. The panel has a thermal transmittance u-value ranging from 0.1 to 0.17 W/m²° C.

This application claims the benefit of U.S. Provisional Application No. 61/617,045 filed Mar. 29, 2012, the disclosure of which is incorporated in its entirety by reference herein.

### TECHNICAL FIELD

The disclosed embodiments relate to an in-situ foam core thermal management system and method of manufacturing of same.

### BACKGROUND

Manufacturers attempt to insulate an internal cavity of an article from the external environment. It is advantageous to have minimal thermal transfer between the internal cavity in the external environment. It is also advantageous to have the walls of the energy management system be as structural and as light as possible as well as economical. Adding more insulation increases the cost and weight of the energy management system article.

Certain manufacturers of energy management system articles use processes such as blow molding or vacuum forming followed by costly secondary operation of filling the cavity formed by the molding process with an injected foam, such as polyurethane foam. Other manufacturers of energy management system articles, such as refrigerators, have a large number of individual subcomponents, many of which involve bending of sheet metal, followed by secondary operations of filling the cavity formed by the subcomponents with injected foam.

### SUMMARY

In at least one embodiment, a thermal management system includes a panel having a periphery and a skin having a thermal bond to an in-situ foam core. The panel has a thermal transmission U-value ranging from 0.1 to 0.17 W/m²° C.

### BRIEF DESCRIPTION OF THE DRAWINGS

FIG. 1 schematically illustrates panels for a refrigerator system according to at least one embodiment;

FIG. 2 schematically illustrates panels for a tote according to at least one embodiment;

FIG. 3 schematically illustrates panels for a personal cooler according to at least one embodiment;

FIG. 4 schematically illustrates a beer keg according to at least one embodiment; and

FIG. 5 schematically illustrates a refrigerated van for a semi-trailer according to at least one embodiment.

### DETAILED DESCRIPTION

Except where expressly indicated, all numerical quantities in the description and claims, indicated amounts of material or conditions of reaction and/or use are to be understood as modified by the word “about” in describing the broadest scope of the present invention. Practice within the numerical limits stated should be desired and independently embodied. Ranges of numerical limits may be independently selected from data provided in the tables and description. The description of the group or class of materials as suitable for the purpose in connection with the present invention implies that the mixtures of any two or more of the members of the group or classes are suitable. The description of constituents in chemical terms refers to the constituents at the time of addition to any combination specified in the description and does not necessarily preclude chemical interaction among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same techniques previously or later referenced for the same property. Also, unless expressly stated to the contrary, percentage, “parts of,” and ratio values are by weight, and the term “polymer” includes “oligomer,” “co-polymer,” “terpolymer,” “pre-polymer,” and the like.

It is also to be understood that the invention is not limited to specific embodiments and methods described below, as specific composite components and/or conditions to make, of course, vary. Furthermore, the terminology used herein is used only for the purpose of describing particular embodiments of the present invention and is not intended to be limiting in any way.

It must also be noted that, as used in the specification and the pending claims, the singular form “a,” “an,” and “the” comprise plural reference unless the context clearly indicates otherwise. For example, the reference to a component in the singular is intended to comprise a plurality of components.

Throughout this application, where publications are referenced, the disclosure of these publications in their entirety are hereby incorporated by reference into this application to more fully describe the state-of-art to which the invention pertains.

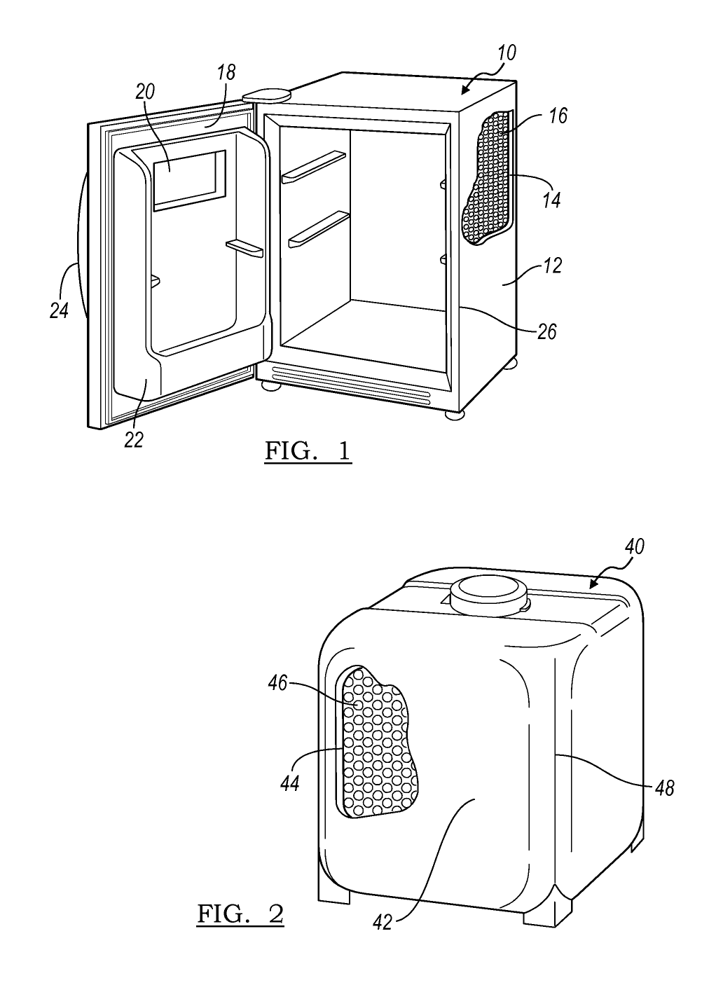

FIG. 1 schematically illustrates a refrigerator 10 having a panel 12. Panel 12 has a wall 14 with a thermal bond (not shown) to an in-situ foam core 16, according to at least one embodiment. In another embodiment, a door panel 18 includes an inner surface having an embossment 20 and a protrusion 22 molded into at least one surface of door panel 18. Attached to door panel 18 is a refrigerator handle 24 having a skin (not shown) and an in-situ foam core (not shown).

FIG. 2 schematically illustrates a tote 40 suitable for holding relatively high-temperature liquids, such as liquid asphalt, liquid malic acid, and molten sulfur, in at least one embodiment. Tote 40, in another embodiment, is suitable for holding sub-ambient temperature liquids, such as liquid nitrogen, as well as refrigerated produce requiring temperature in the range from 0° C. to 4° C.

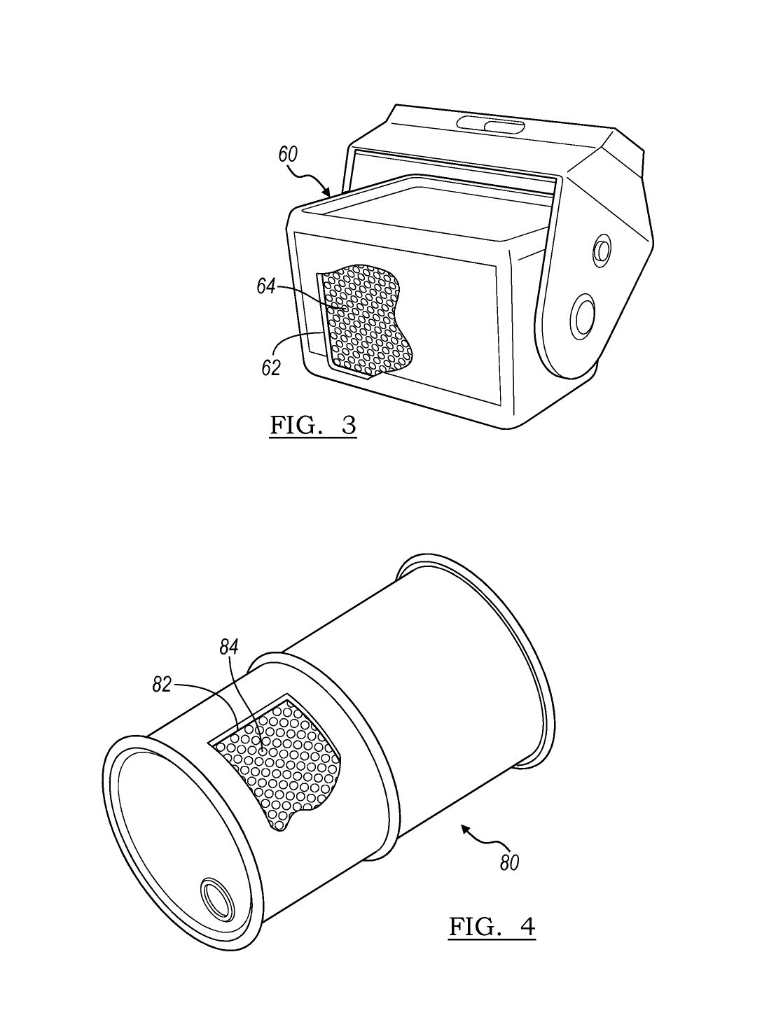

FIG. 3 schematically illustrates a personal cooler 60 having a skin 62 and an in-situ foam core 64.

In-situ foam core 32 is prepared by injecting steam into pre-expanded beads dispensed into cavity (not shown) defined by walls 14 (FIG. 1), 44 (FIG. 2), and/or 62 (FIG. 3). It should be understood that the pre-expanded beads may have different original diameters and form, when fully expanded, in-situ foam cores 16, 46, and/or 64, respectively.

FIG. 4 schematically illustrates a beer keg 80 according to at least one embodiment. Beer keg 80 has a wall 82 having a thermal bond 86 to an in-situ foam core 84. The light weight and durability of beer keg 80 relative to a conventional aluminum beer keg are appreciated by customers. In addition, beer distributors appreciate that the expensive aluminum kegs that some users recycle for cash are replaced by beer keg 80, for which recyclers pay relatively less cash.

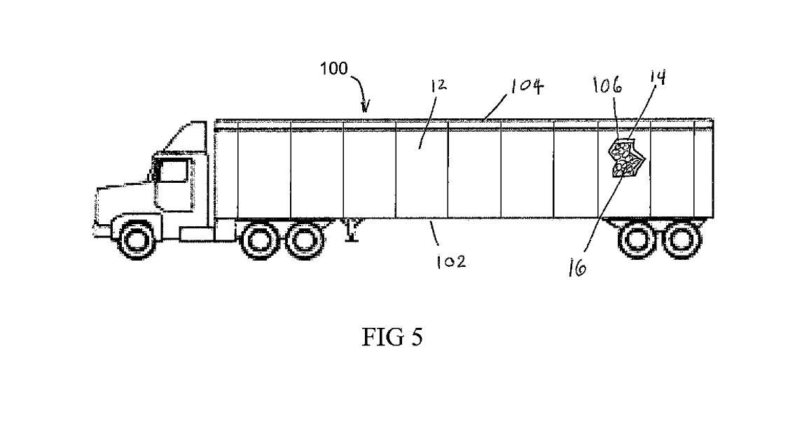

FIG. 5 schematically illustrates a semi-trailer truck with a van 100. Van 100 is comprised of a plurality of panels 12, according to at least one embodiment. Panels 12, in at least one embodiment, are interlocked into a van floor 102 and/or a van roof 104. Panels 12 have the wall 14 with a thermal bond 106 to the in-situ foam core 16. Thermal bond 106 includes a cooled member of a molten or softened portion of skin 14, a molten or softened portion of in-situ foam core 16, and a co-mingled layer of skin 14 and in-situ foam core 16.

The steps of expanding the pre-expanded beads to fully expanded beads 42 are illustrated by U.S. patent application Ser. Nos. 13/358,181 and 13/005,190, and U.S. Publication No. 2012-0104110-A1 published May 3, 2012, all of which are incorporated herein by reference.

In at least one embodiment, wall 14, 44, and/or 62 thickness may range from 0.02 inches to 0.5 inches. In another embodiment, wall 14, 44, and/or 62 thickness may range from 0.125 inches to 0.25 inches.

In at least one embodiment, in-situ core 16, 46, and or 64 thickness may range from 0.15 inches to 6 inches. In another embodiment, in-situ foam core 16, 46, and/or 64 thickness may range from 0.2 inches to 4 inches. In another embodiment, in-situ foam core 16, 46, and/or 64 thickness may range from 0.5 inches to 1 inch.

Walls 14, 44, 62, and/or 82, in at least one embodiment, are formed of a composition of any moldable composition. Non-limiting examples of the composition include, but are not limited to, a liquid silicone rubber, a synthetic rubber, a natural rubber, a liquid crystal polymer, a synthetic polymer resin, and a natural polymer resin. In another embodiment, walls 14, 44, 62, and/or 82 are formed of a composition of a thermoplastic polymer, a thermoset polymer, or blends thereof having a viscosity ranging from 0.1 grams/10 min. to 40 grams/10 min. The viscosity is measured according to ASTM D-1238 at 190° C. with a 2.16 kg weight. In yet another embodiment, walls 14, 44, 62, and/or 82 are formed of a composition of a polyolefin including a polypropylene and polyethylene having a viscosity ranging from 1 grams/10 min. to 30 grams/10 min.

In-situ foam core 16, 46, 64, and/or 84, in at least one embodiment, is formed of a composition of any fluid-expandable material. Examples of fluid-expandable material include, but are not limited to, a polyolefin polymer composition, a biopolymer expandable bead, an alkenyl aromatic polymer or copolymer, a vinyl aromatic polymer resin composition, and a polystyrene polymer composition. In at least one embodiment, the polyolefin polymer composition includes polyolefin homopolymers, such as low-density, medium-density, and high-density polyethylenes, isotactic polypropylene, and polybutylene 1, and copolymers of ethylene or polypropylene with other polymerized bull monomers such as ethylene-propylene copolymer, and ethylene-vinyl acetate copolymer, and ethylene-acrylic acid copolymer, and ethylene-ethyl acrylate copolymer, and ethylene-vinyl chloride copolymer. These polyolefin resins may be used alone or in combination. Preferably, expanded polyethylene (EPE) particles, cross-linked expanded polyethylene (xEPE) particles, polyphenyloxide (PPO) particles, biomaterial particles, such as polyactic acid (PLA), and polystyrene particles are used. In at least one embodiment, the polyolefin polymer is a homopolymer providing increased strength relative to a copolymer. It is also understood that some of the particles may be unexpanded, also known as pre-puff, partially and/or wholly pre-expanded without exceeding the scope or spirit of the contemplated embodiments.

Pre-expanded beads, in at least one embodiment, are the resultant bead after raw bead has undergone a first expansion step of a two-step expansion process for beads. During the first expansion step, raw bead is expanded to 2% to 95% of the fully expanded bead size. The fully expanded bead is the bead that forms in-situ foam core. In another embodiment, pre-expanded bead is the result of the first expansion step where raw bead is expanded from 25% to 90% of the fully-expanded bead size.

A fluid for the second expansion step of the two-step expansion process for beads causes the pre-expanded beads to expand completely to form the fully expanded beads. Examples of the fluid include, but are not limited to, steam and superheated steam.

Polyolefin beads and methods of manufacture of pre-expanded polyolefin beads suitable for making the illustrated embodiments are described in Japanese Patent Nos. JP60090744, JP59210954, JP59155443, JP58213028, and U.S. Pat. No. 4,840,973, all of which are incorporated herein by reference. Non-limiting examples of expanded polyolefins are ARPLANK®, and ARPRO®, available from JSP, Inc. (Madison Heights, Mich.). The expanded polypropylene, such as JSP ARPRO™ EPP, has no external wall.

In at least one embodiment, in-situ foam core 16, 46, 64, and/or 84 density, after expansion by steam, ranges from 1 lb/ft³ to 25 lbs/ft³. In at least one embodiment, in-situ foam core 16, 46, 64, and/or 84 density ranges from 1.5 lbs/ft³ to 15 lbs/ft³. In at least one embodiment, in-situ foam core 16, 46, 64, and/or 84 density ranges from 2 lbs/ft³ to 9 lbs/ft³. In at least one embodiment, in-situ foam core 16, 46, 64, and/or 84 density ranges from 3 lbs/ft³ to 6 lbs/ft³.

In at least one embodiment, walls 14, 44, 62, and/or 82, with a range of 0.025 inch thickness to 0.1 inch thickness, are comprised of metallocene polypropylene. Such a combination is found to improve adhesion between walls 14, 44, 62, and/or 82 and in-situ foam core from 16, 46, 64, and/or 84 formed of EPP.

Refrigerator 10, tote 40, beer keg 80, personal cooler 60, and van 100, in at least one embodiment, have thermal transmittance u-values ranging from 0.1 to 0.17 W/m²° C. In another embodiment, refrigerator 10, tote 40, personal cooler 60, beer keg 80, and van 100 have thermal transmission u-values ranging from 0.12 to 0.16 W/m²° C.

Panel 18 of refrigerator 10 consolidates a number of individual components into one moldable unit providing a substantial cost improvement relative to current refrigerator construction methods.

Personal cooler 60 consolidates two parts into one relative to current personal cooler construction methods, but also avoids the extra labor costs of the secondary operation for injecting polyurethane foam that is in use with current cooler construction methods. Further, personal cooler 60 also avoids use of potentially destructive blowing agents relative to the environment.

It is understood that while refrigerator 10, tote 40, personal cooler 60, beer keg 80, and van 100 are illustrated in embodiments, other similar structures, such as commercial ice making machine systems; chemical tank covers; hot tub covers, walls, and bases; liquid storage facilities for use at ports, including those with food-grade composition walls; and in-flight beverage carts are some non-limiting articles amenable to manufacture by this method.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A thermal management system, comprising:
a panel having a periphery and a skin having a thermal bond to an in-situ foam core, wherein the panel has a thermal transmittance u-value ranging from 0.1 to 0.17 W/m²° C.

2. A system of claim 1, wherein a plurality of the panels are configured with peripheries adjacent to each other forming a box with at least one panel comprising a door connected to the box.

3. A system of claim 2, wherein the box and door comprise a refrigerator.
